(19) United States
(12) Patent Application Publication
(10) Pub. No.: US 2025/0080440 A1
(43) Pub. Date: Mar. 6, 2025

(54) COMMUNICATION APPARATUS, COMMUNICATION SYSTEM, COMMUNICATION METHOD, AND PROGRAM

(71) Applicant: NEC Corporation, Tokyo (JP)

(72) Inventors: Yuki Ashino, Tokyo (JP); Masahiro Karube, Tokyo (JP)

(73) Assignee: NEC Corporation, Tokyo (JP)

(21) Appl. No.: 18/813,134

(22) Filed: Aug. 23, 2024

(30) Foreign Application Priority Data
Aug. 29, 2023 (JP) 2023-139161

(51) Int. Cl. H04L 43/0852; H04L 47/283

(52) U.S. Cl. CPC H04L 43/0852; H04L 47/283

(57) ABSTRACT

A communication apparatus includes: a packet identification information acquisition part that acquires packet identification information that identifies a packet received from a transmission source; a packet identification information holding part that holds the packet identification information; a transferring part that transfers the packet received to at least one other communication apparatus; a packet identification information collation determination part that collates response packet identification information that identifies a response packet from the at least one other communication apparatus with the packet identification information held in the packet identification information holding part to determine whether or not the response packet and the packet are the same or corresponding packets; and a transmission part that transmits the packet to a transmission destination on a basis of a determination result of the packet identification information collation determination part.

### CROSS REFERENCE TO RELATED APPLICATION

The present invention is based upon and claims the benefit of the priority of Japanese patent application No. 2023-139161 filed on Aug. 29, 2023, the disclosure of which is incorporated herein in its entirety by reference thereto.

### FIELD

The present invention relates to a communication apparatus, communication system, communication method, and program capable of generating a natural and sufficient network delay.

### BACKGROUND

In a network, communication delays occur depending on the physical distance between the communication participants. The communication delay time is called latency, and the round trip latency until a response arrives to a request transmitted is called RTT (Round Trip Time). When developing a communication program, it is often necessary to keep this RTT in mind, and a network emulator that intentionally increases or decreases the RTT may be used during development.

Patent Literature (PTL) 1 discloses an invention of a following network emulator apparatus. In this invention, a virtual node in the network emulator is provided with a timer and a delay processing part to generate a delay time between transmitting a request to the virtual node and receiving a response to that request. The delay processing part performs processing that stores the response to the request for a predetermined time based on a timing measured by the timer and transmits the response after the predetermined time has elapsed. A setting of a degree of delay to be generated in the delay processing part is determined by a predetermined delay model.
[PTL 1] Japanese Patent Kokai Publication No. JP-P2011-101140A

### SUMMARY

The disclosure of the literature cited above is incorporated herein in its entirety by reference thereto. The following analysis is given by the present inventors.

As described above, the invention disclosed in PTL 1 is able to emulate RTT in communication by generating a delay in network communication. Additionally, by adjusting parameters of the model, it is possible to control the length of a communication path where a delay occurs, i.e., an amount of the delay.

However, in the invention disclosed in PTL 1, first, in order to generate a predetermined time delay, it is necessary to provide a function of waiting for a response packet to be transferred and storing thereof. In other words, the packet needs to be stored in a storage area, and the storage area needs to be as large as the communication bandwidth multiplied by the delay time. The problem is that an extremely long delay time to be generated would require a huge area of storage area. Second, since delays are generated on the basis of a mathematical model, there is a problem that a distribution of delays may not necessarily be the same as a distribution of delays in an actual network.

Therefore, in an aspect of the present invention, an object is to provide a communication apparatus, a communication system, a communication method, and a program that can generate a sufficient and natural network delay.

According to a first aspect of the present invention, there is provided a communication apparatus including:
a packet identification information acquisition part that acquires packet identification information that identifies a packet received from a transmission source;
a packet identification information holding part that holds the packet identification information;
a transferring part that transfers the packet received to at least one other communication apparatus;
a packet identification information collation determination part that collates response packet identification information that identifies a response packet from the at least one other communication apparatus with the packet identification information held in the packet identification information holding part to determine whether or not the response packet and the packet are the same or corresponding packets; and
a transmission part that transmits the packet to a transmission destination on a basis of a determination result of the packet identification information collation determination part.

According to a second aspect of the present invention, there is provided a communication system including:
a response apparatus; and
a communication apparatus, wherein
the response apparatus comprises a response part that responds by generating a response packet using a payload of a received packet as is, and
the communication apparatus comprises:
a packet identification information acquisition part that acquires packet identification information that identifies a packet received from a transmission source;
a packet identification information holding part that holds the packet identification information;
a transferring part that transfers the packet received to the response apparatus;
a packet identification information collation determination part that collates response packet identification information that identifies the response packet from the response apparatus with the packet identification information held in the packet identification information holding part to determine whether or not the response packet and the packet are the same or corresponding packets; and
a transmission part that transmits the packet to a transmission destination on a basis of a determination result of the packet identification information collation determination part.

According to a third aspect of the present invention, there is provided a communication method causing a computer to execute the following, the communication method including:
acquiring packet identification information that identifies a packet received from a transmission source;
storing the packet identification information in a storage area;
transferring the packet received to at least one other communication apparatus;
collating response packet identification information that identifies a response packet from the at least one other communication apparatus with the packet identification information stored in the storage area to determine whether or not the response packet and the packet are the same or corresponding packets; and
transmitting the packet to a transmission destination on a basis of a determination result.

According to a fourth aspect of the present invention, there is provided a program causing a computer to execute:
acquiring packet identification information that identifies a packet received from a transmission source;
storing the packet identification information in a storage area;
transferring the packet received to at least one other communication apparatus;
collating response packet identification information that identifies a response packet from the at least one other communication apparatus with the packet identification information stored in the storage area to determine whether or not the response packet and the packet are the same or corresponding packets; and
transmitting the packet to a transmission destination on a basis of a determination result.

Further, this program can be recorded on a computer-readable storage medium. The storage medium may be a non-transitory one such as a semiconductor memory, a hard disk, a magnetic recording medium, an optical recording medium, and the like. The present invention can also be realized as a computer program product.

According to each aspect of the present invention, there can be provided a communication apparatus, a communication system, a communication method, and a program that can generate a sufficient and natural network delay.

### BRIEF DESCRIPTION OF DRAWINGS

FIG. 1 is a block diagram illustrating an example of a configuration of a communication apparatus of the present disclosure.

FIG. 2 is a drawing illustrating an overview of processes performed by the communication apparatus of the present disclosure.

FIG. 3 is a drawing illustrating an example of packet identification information of the present disclosure.

FIG. 4 is a flowchart for explaining an operation of the communication apparatus of the present disclosure.

FIG. 5 is a block diagram illustrating an example of a hardware configuration of the communication apparatus of the present disclosure.

FIG. 6 is a drawing illustrating an overview of processes performed by the communication apparatus of the present disclosure.

FIG. 7 is a block diagram for illustrating an example of a configuration of the communication apparatus of the present disclosure.

FIG. 8 is a drawing illustrating examples of delay policies in the communication apparatus of the present disclosure.

FIG. 9 is a drawing illustrating different examples of delay policies in the communication apparatus of the present disclosure.

FIG. 10 is a drawing illustrating an overview of processes performed by the communication apparatus of the present disclosure.

FIG. 11 is a flowchart for explaining an operation of the communication apparatus of the present disclosure.

FIG. 12 is a drawing illustrating an example of a configuration of a communication system of the present disclosure.

FIG. 13 is a flowchart for explaining an operation of the communication system of the present disclosure.

### EXAMPLE EMBODIMENTS

First, an overview of an example embodiment will be described. Note that reference signs in the drawings provided in the overview are for the sake of convenience for each element as an example to promote better understanding, and description of the overview is not to impose any limitations. In the present disclosure, the drawings may relate to one or more example embodiments.

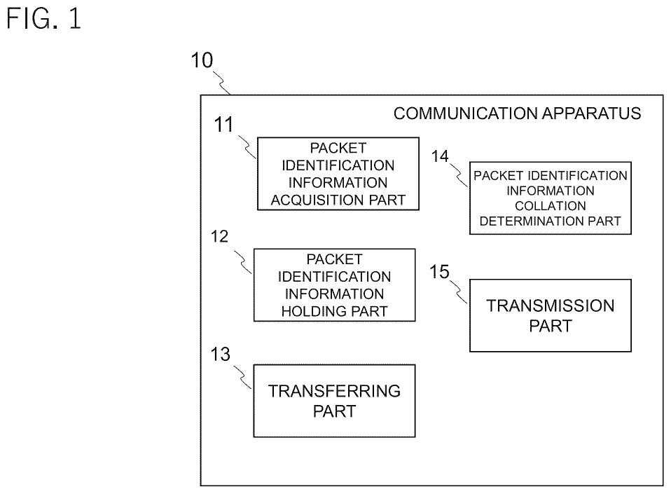

FIG. 1 is a block diagram illustrating an example of a configuration of a communication apparatus of the present disclosure. A communication apparatus 10 of the present disclosure has a packet identification information acquisition part 11, a packet identification information holding part 12, a transferring part 13, a packet identification information collation determination part 14, and a transmission part 15.

The packet identification information acquisition part 11 acquires packet identification information that identifies a packet received from a transmission source. The packet identification information holding part 12 holds the packet identification information. The transferring part 13 transfers the received packet to at least one other communication apparatus. The packet identification information collation determination part 14 collates response packet identification information that identifies a response packet from the at least one other communication apparatus with the packet identification information held in the packet identification information holding part to determine whether or not the response packet and the packet are the same packets or corresponding packets. The transmission part 15 transmits the packet to a transmission destination on a basis of a determination result of the packet identification information collation determination part 14.

As described, the communication apparatus of the present disclosure transfers a packet received from a transmission source to the at least one other communication apparatus. The communication apparatus receives a response packet to the transferred packet and transmits it to a destination address. Thus, the communication apparatus can generate a communication delay by transferring and rerouting a packet once to the at least one other communication apparatus. By acquiring the packet identification information before transferring the packet, the communication apparatus can determine whether or not the acquired packet identification information matches the identification information of the response packet that arrives in response to the packet transferred to the at least one other communication apparatus and can deliver the packet to the transmission destination by transmitting it on a basis of a determination result.

A delay on a network generated by the processes described above are not emulated and generated by a model, but is generated by actual communication and shows a more natural distribution than a delay distribution generated by a model. Further, a long delay can be generated by a sufficiently long distance to at least one other communication apparatus at a transfer destination.

### First Example Embodiment

### [Process Overview]

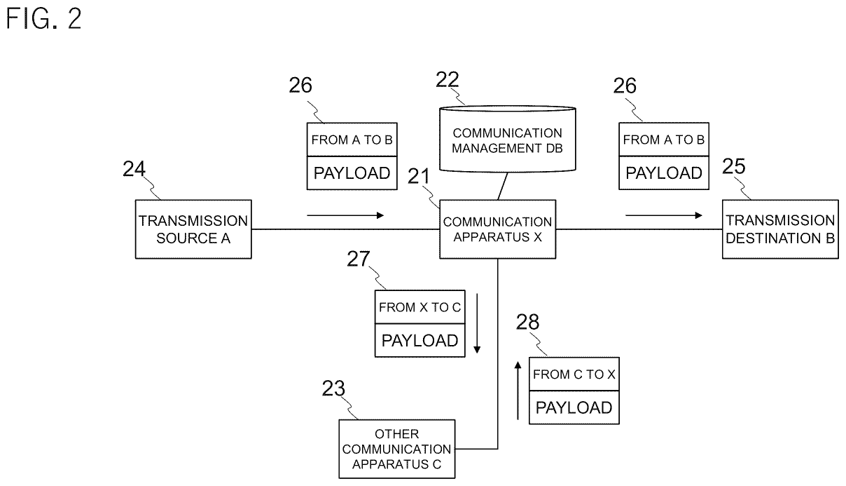

FIG. 2 is a drawing illustrating an overview of processes performed by a communication apparatus of the present disclosure. As illustrated in the drawing, a communication apparatus X 21, a communication management DB 22 connected thereto, and at least one other communication apparatus C 23 are provided. Here, an application program communicating between a transmission source A 24 and a transmission destination B 25 is tested to see if it operates properly under a predetermined delay.

The transmission source A 24 transmits a packet 26 to the transmission destination B 25. A header of the packet 26 includes a transmission source A and a transmission destination (destination address) B. The packet 26 reaches the communication apparatus X 21. The communication apparatus X 21 acquires packet identification information of the packet 26 and stores it in the communication management DB 22. The communication apparatus X 21 rewrites the header of the packet 26 to generate a packet 27 and transmits the packet 27 to the at least one other communication apparatus C 23. The at least one other communication apparatus C 23 receives the packet 27 and again transmits it to the communication apparatus X 21 as a response packet 28. The communication apparatus X 21 receives it, collates packet identification information in the communication management DB 22 for finding packet identification information that matches the identification information of the response packet 28. The response packet 28, which is determined to match the identification information of the packet 26 as a result of collation, is transmitted to the transmission destination B by setting the transmission source as A and the transmission destination (destination address) as B in the header thereof.

Thus, the communication apparatus X 21 can generate a delay by transferring a packet to be transmitted to the transmission destination B, from the communication apparatus X 21 to the at least one other communication apparatus C 23 and back and bypassing thereof. In order to generate the delay, the communication apparatus X 21 transfers the packet 26 and rewrites the transmission source and the transmission destination in the header information thereof. However, it is possible to maintain an identity by acquiring the packet identification information at the communication apparatus X 21 and matching it with the packet identification information of the response packet 28.

### [Apparatus Configuration]

An example of a configuration of the communication apparatus according to the present disclosure is the same as that according to the above example embodiment and is illustrated in FIG. 1. As in the above example embodiment, a communication apparatus 10 of the present disclosure has a packet identification information acquisition part 11, a packet identification information holding part 12, a transferring part 13, a packet identification information collation determination part 14, and a transmission part 15.

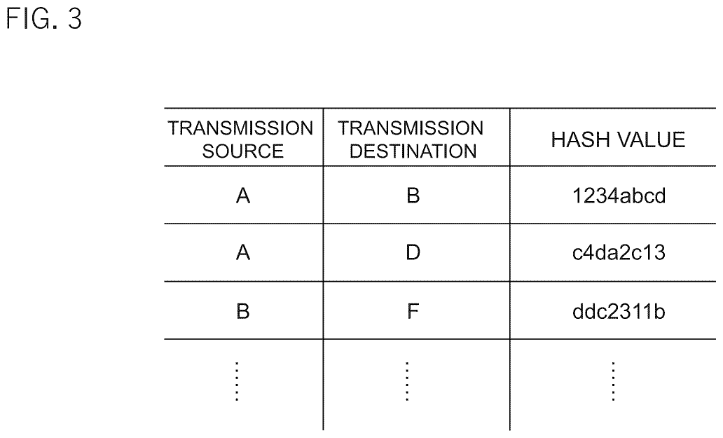

The packet identification information acquisition part 11 acquires packet identification information that identifies a packet received from a transmission source. To “acquire” means to generate and extract information necessary to identify a packet from data of the packet. This means, for example, a process of acquiring a source address or a destination address from a header information data of the packet, calculating a hash value of a payload data, and so on. FIG. 3 is a drawing illustrating an example of the packet identification information. As illustrated in the drawing, transmission sources, transmission destinations, and hash values of payloads are listed. The first row corresponds to the example illustrated in FIG. 2: the transmission source is “A,” the transmission destination is “B,” and the hash value of the payload is “1234abcd.” Such information may be stored, for example, as a list, queue, or stack in the order of time of reception.

More concretely, the transmission source and the transmission destination may be IP address entries in “Source Address” and “Destination Address” in an IP header, respectively. The packet identification information may include the time of reception in addition to these pieces of information. In order to indicate the uniqueness of the packet in each row, in addition to the hash value of the payload, a value combining “Identification” and “Fragment Offset” in the IP header may be used, for example. By using the hash value of the payload, etc., as the identification information, instead of employing the entire data of the packet, first, it is possible to process quickly when the packet identification information collation determination part 14, described later, identifies a response packet. Second, it is possible to save storage area in the packet identification information holding part 12, described later.

The packet identification information holding part 12 holds the packet identification information. It stores and holds the packet identification information acquired by the packet identification information acquisition part 11 and corresponds to the communication management DB 22 in FIG. 2. The communication management DB 22 is provided outside the communication apparatus X 21 in FIG. 2, but it may be provided inside the communication apparatus X 21.

The transferring part 13 transfers a received packet to at least one other communication apparatus. More concretely, the transferring part 13 rewrites a header of the received packet and executes a process to transmit the packet to the at least one other communication apparatus. In FIG. 2, the transferring part 13 rewrites the header of the packet 26 to that of the packet 27 and transmits the packet to the at least one other communication apparatus C 23.

The packet identification information collation determination part 14 collates response packet identification information that identifies a response packet received from the at least one other communication apparatus with the packet identification information held in the packet identification information holding part 12 to determine whether or not the response packet and the packet are the same or corresponding packets. The at least one other communication apparatus responses the packet transferred by the transferring part 13 to the communication apparatus as a response packet without changing the payload. The communication apparatus receives the response packet and performs a collation process for the packet identification information. More concretely, first, the communication apparatus acquires the response packet and processes it in the same manner as the stored packet identification information to acquire the response packet identification information. Then, the communication apparatus searches the packet identification information holding part 12 using the response packet identification information as a key to determine whether or not the packet identification information holding part 12 holds the same or corresponding packet identification information. If it is determined that the same or corresponding packet identification information has been found as a result, the communication apparatus hands data of the packet to the transmission part 15 described later.

The transmission part 15 transmits the packet to the transmission destination on a basis of the determination result of the packet identification information collation determination part 14. As described above, the transmission part 15 executes the process of transmitting data of the response packet received from the packet identification information collation determination part 14 to the transmission destination. More concretely, the transmission part 15 rewrites the transmission destination (destination address) in the header of the response packet to the transmission destination in the packet identification information held in the packet identification information holding part 12 to transmit the packet to the transmission destination.

Note that, if the packet identification information collation determination part 14 finds no match as a result of a process of searching the packet identification information holding part 12, it terminates the process or returns to the process of receiving another packet from the transmission source by the packet identification information acquisition part 11, again.

In addition, when the packet identification information collation determination part 14 collates the response packet identification information with the packet identification information held in the packet identification information holding part 12 and determines that the response packet and the packet are the same or corresponding packets, the transmission part 15 may delete the packet identification information of the packet to be the same or corresponding to the response packet held therein while transmitting the packet to the source.

Although not illustrated in FIG. 1, the communication apparatus 10 may be configured to further have a timeout processing part. When a response packet from the at least one other communication apparatus does not arrive within a predetermined time after the transferring part 13 has transferred a packet, the timeout processing part may delete the packet identification information held in the packet identification information holding part 12 and corresponding to the packet.

### [Operation]

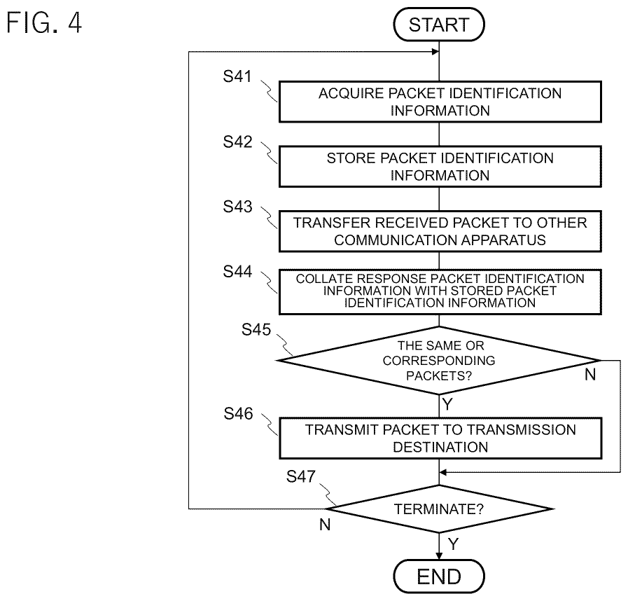

FIG. 4 is a flowchart for explaining an operation of the communication apparatus 10 of the present disclosure. As shown in the drawing, when the communication apparatus 10 starts to operate, it acquires the packet identification information of a packet received from a transmission source (step S41). The communication apparatus 10 stores the acquired packet identification information in the storage area (step S42). Next, the communication apparatus transfers the received packet to at least one other communication apparatus (step S43). When receiving a response packet from the at least one other communication apparatus, the communication apparatus 10 collates the response packet identification information with the packet identification information stored in the storage area (step S44). As a result of the collation, the communication apparatus determines whether or not the response packet and the packet are the same or corresponding packets (step S45). If the same or corresponding packet exists (Yes in the step S45), the communication apparatus transmits the packet to the transmission destination (step S46) and determines whether or not to terminate the operation (step S47). If the same or corresponding packet does not exist (No in the step S45), the communication apparatus determines whether or not to terminate the operation (the step S47). If the communication apparatus determines not to terminate the operation (No in the step S47), it again receives a transmitted packet and returns to the process of acquiring the packet identification information therefrom (the step S41).

### [Hardware Configuration]

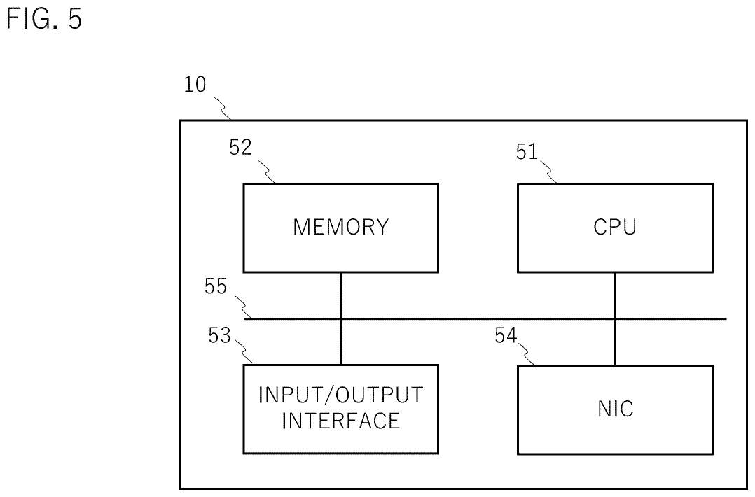

Next, the following describes the hardware configuration of the communication apparatus according to the first example embodiment. FIG. 5 is a block diagram illustrating an example of the hardware configuration of the communication apparatus 10 according to the first example embodiment.

The communication apparatus 10, which configures a communication apparatus, can be configured by an information processing apparatus (computer) and is provided with a configuration illustrated in FIG. 5. For example, the communication apparatus 10 is provided with a CPU (Central Processing Unit) 51, a memory 52, an input/output interface 53, a NIC (Network Interface Card) 54, which is communication means, and so on. These elements are connected to each other by an internal bus 55.

It should be noted that the configuration illustrated in FIG. 5 is not intended to limit the hardware configuration of each apparatus configuring the communication apparatus 10. The communication apparatus 10 may include hardware not shown in the drawing, and the input/output interface 53 may be omitted if not needed. Further, the number of CPUs, etc. included in the communication apparatus 10 is not intended to be limited to the example illustrated in FIG. 5, and for example, a plurality of CPUs may be included in each apparatus.

The memory 52 is a RAM (Random Access Memory), a ROM (Read-Only Memory), or an auxiliary storage device (such as a hard disk).

The input/output interface 53 is means that serves as an interface to a display device or an input device not shown in the drawing. For example, the display device is a liquid crystal display. The input device is, for example, a device that accepts user operations such as a keyboard or a mouse.

The functions of the communication apparatus 10 are realized by processing modules such as a packet identification information acquisition program, a transferring program, a packet identification information collation determination program, and a transmission program, and a packet identification information list held in the memory 52.

For example, the processing modules above are realized by causing the CPU 51 to execute each program stored in the memory 52. Further, this program may be downloaded via a network or updated using a storage medium storing the program. The processing modules may be realized by a semiconductor chip. In other words, there should be some means that executes the functions performed by the processing modules using some kind of hardware and/or software.

### [Hardware Operation]

When the communication apparatus 10 starts operation, the packet identification information acquisition program is called from the memory 52 and is executed by the CPU 51. The program extracts the packet identification information from data of a packet received from a transmission source. More concretely, the program calculates and extracts at least, address information of the transmission source and a transmission destination (destination address) of the packet and a hash value of a payload thereof through arithmetic processing of the CPU 51. The extracted packet identification information is stored in the memory 52.

Next, the transferring program is called from the memory 52 and is executed by the CPU 51. The program rewrites the header information of the packet received from the transmission source and transmits the packet to at least one other communication apparatus. More concretely, the program makes the transmission source in the header information of the packet the communication apparatus 10, and the transmission destination (destination address) thereof the at least one other communication apparatus.

When a response packet is received from the at least one other communication apparatus, the packet identification information collation determination program is called from the memory 52 and is executed by the CPU 51. The program extracts response packet identification information from the response packet transmitted from the at least one other communication apparatus and received. More concretely, the program calculates and extracts a hash value of a payload of the response packet through arithmetic processing of the CPU 51. Next, the program uses the hash value, which is the extracted response packet identification information, as a key to collate and search in, the packet identification information stored in the memory 52. If it is determined that a record having the same hash value exists as a result, the program acquires the packet identification information and temporarily stores it in the memory 52. The packet identification information may be searched in order of newest information (record) or oldest information.

Next, the transmission program is called from the memory 52 and is executed by the CPU 51. The program reads the packet identification information temporarily held in the memory 52 and rewrites the header information of the corresponding response packet. More concretely, the program rewrites it by writing a transmission source address and a transmission destination address included in the read packet identification information in the header information of the corresponding response packet. The rewritten packet is transmitted to a destination address via the NIC 54.

### Effects

As described above, the communication apparatus 10 of the present disclosure can generate a delay by transferring a packet received from a transmission source to at least one other communication apparatus. At this time, by utilizing the packet identification information, it is possible to provide a communication apparatus, communication system, communication method, and program that can generate a sufficient and natural network delay while maintaining data consistency.

### Second Example Embodiment

A second example embodiment is based on the first example embodiment and further introduces a delay policy, which is information about an element for generating a delay, and provides a communication apparatus 10 that generates a delay on a basis of the delay policy.

### [Process Overview]

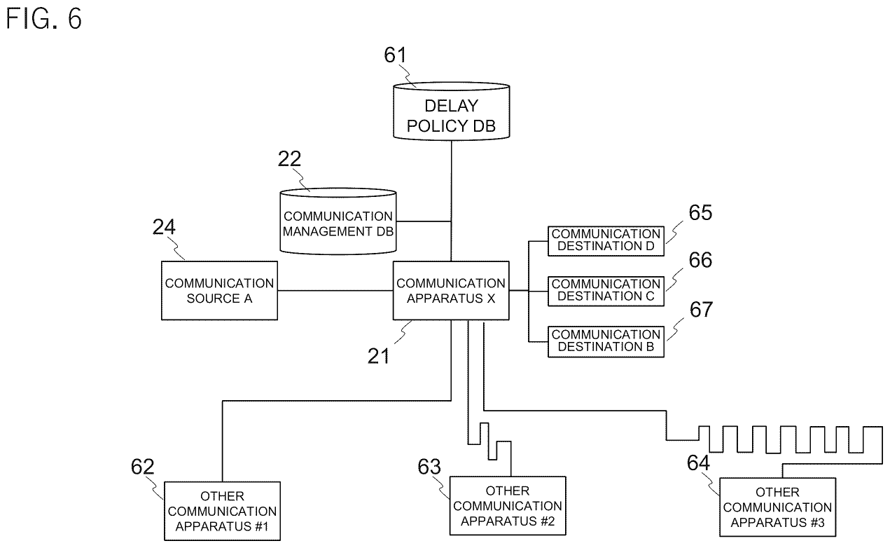

FIG. 6 is a drawing illustrating an overview of processes performed by a communication apparatus 10 of the present disclosure. The communication apparatus 10 of the second example embodiment differs from that of the first example embodiment in that it has a delay policy DB 61 as illustrated in FIG. 6 and there is a plurality of other communication apparatuses (62 to 64) and communication destinations (65 to 67) connected to a communication apparatus X 21. The communication apparatus X 21 performs transfer processing to a response apparatus on a basis of the delay policy held in the delay policy DB 61. For example, suppose that there is a policy that when a communication destination is the communication destination C 66, an other communication apparatus #3 is used. If a transmission destination of a communication source A 24 is the transmission destination C66, the communication apparatus X 21 transfers a packet to the other communication apparatus #3 to generate a delay.

### [Apparatus Configuration]

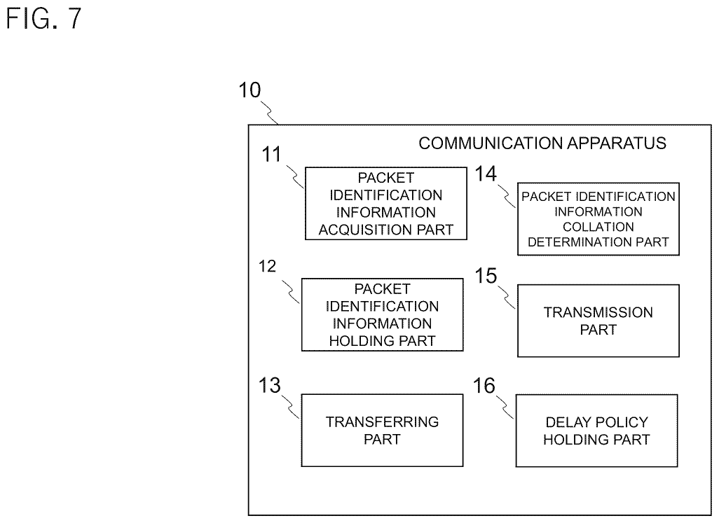

FIG. 7 is a block diagram for illustrating an example of a configuration of the communication apparatus 10 of the present disclosure. The communication apparatus 10 of the present disclosure is provided with a packet identification information acquisition part 11, a packet identification information holding part 12, a transferring part 13, a packet identification information collation determination part 14, and a transmission part 15. Since requirements for these configurations have already been described in the above example embodiment, the description thereof will be omitted. The communication apparatus 10 of the present disclosure is characterized in that it is provided with a delay policy holding part 16 and that the transferring part 13 transfers a packet on a basis of the delay policy held in the delay policy holding part 16.

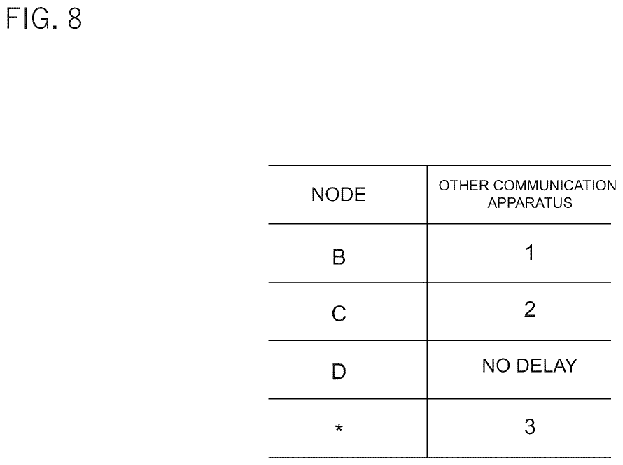

The delay policy holding part 16 holds the delay policy, which is information about an element used to generate a delay. FIG. 8 is a drawing illustrating an example of the delay policy in the communication apparatus 10 of the present disclosure. As illustrated in the drawing, each node to be used is held associated with the at least one other communication apparatus, as a delay policy. For example, if a communication destination B is set as a communication destination, an other communication apparatus #1 is defined as the at least one other communication apparatus, when referring to a row for the node B in the delay policies illustrated in FIG. 8. Therefore, the communication apparatus 10 uses the other communication apparatus #1 in FIG. 6 to generate a delay. The third record indicates a policy of transmitting a packet without delay when the communication destination is, for example, a node D. Further, the fourth record means that the other communication apparatus #3 is applicable when any other node (indicated with an asterisk) is used.

The entry registered in “node” may correspond to a node used as a communication destination or a node used as a communication source. When both are used, the entry in node may be marked in a distinguishable manner, for example, “Destination B (communication destination is B)” or “Source B (communication source is B)”.

The policy described above may be selected on a basis of a required amount of delay. It may be configured that a required delay amount is received via an input/output interface such as a keyboard, and a policy that satisfies the required delay amount is selected. In other words, the communication apparatus is further provided with a required delay amount reception part (not shown in the drawings) that receives a required amount of delay and a delay policy selection part (not shown in the drawings) that selects a delay policy satisfying the required delay amount from predicted amount of delay included in the delay policies held in the delay policy holding part 16. The transferring part 13 transfers a packet on a basis of the delay policy selected by the delay policy selection part.

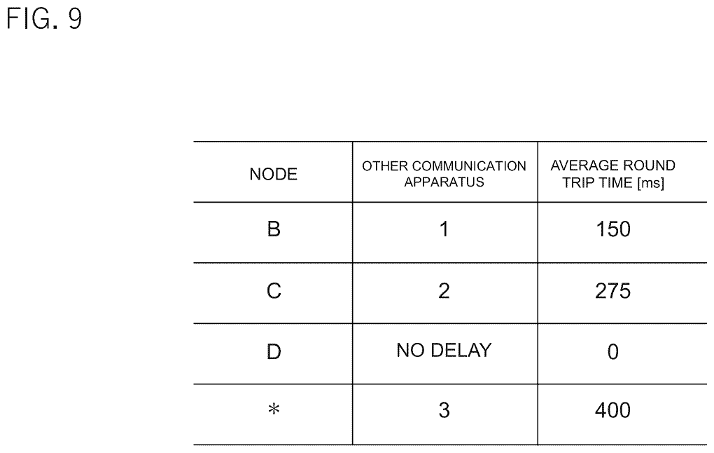

FIG. 9 is a drawing illustrating different examples of delay policies in the communication apparatus 10 of the present disclosure. As illustrated in the drawing, fields of average round trip times are further provided as predicted delay amounts. The average round trip time means the average round trip time, which is the actual round trip time in the past predetermined time period. The delay policy selection part compares the average round trip time, which is the past performance, with a required amount of delay inputted, and selects a policy where the average round trip time satisfies the required amount of delay. If a plurality of policies is applicable, means that accepts input of a selection may be provided.

The delay policies held in the delay policy holding part 16 may include various indices such as the maximum, minimum and median values of round trip times, in addition to the average round trip time, which is the past performance.

### Effects

The communication apparatus 10 of the present disclosure can generate a delay by transferring a packet on a basis of a delay policy. This makes it possible to generate an appropriate delay when the required amount of delay varies depending on the situation. Further, it is possible to generate an appropriated delay by accepting a required amount of delay and selecting a delay policy that satisfies the required amount of delay.

### Third Example Embodiment

The third example embodiment describes a further application example of the communication apparatus 10.

### [Process Overview]

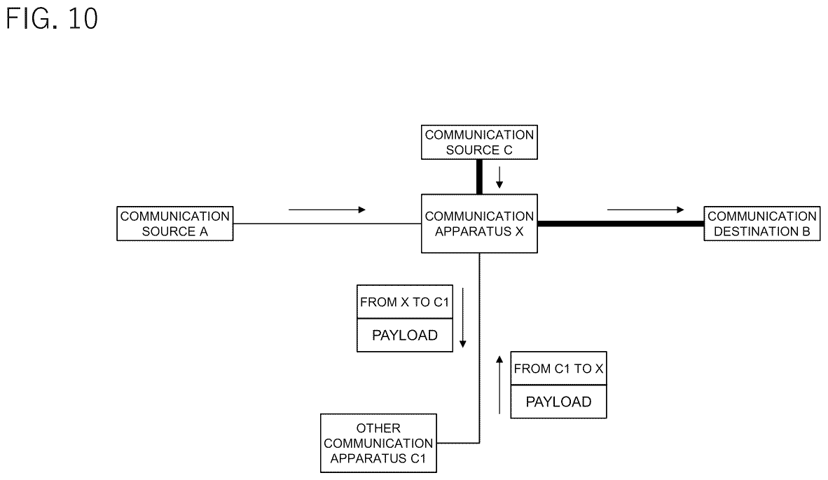

FIG. 10 is a drawing illustrating an overview of processes performed by the communication apparatus 10 of the present disclosure. As illustrated in the drawing, a communication source C is communicating with a communication destination B, and a bandwidth therebetween is almost exclusively occupied by both parties. Here, a communication source A is trying to start communication with the communication destination B, but communication is impossible because the bandwidth between a communication apparatus X and the communication destination B is occupied. Therefore, the communication apparatus X transfers a packet destined for B to at least one other communication apparatus C1 and receives a response packet thereto. Upon receiving the response packet, the communication apparatus X determines whether or not the bandwidth between X and the communication destination B can be secured. As a result, if the communication apparatus X determines that the bandwidth can be secured, it transfers the packet to the communication destination B, and starts communication between A and B. If the communication apparatus X determines that the bandwidth cannot be secured yet, it repeats the process of transferring the packet to the at least one other communication apparatus C1 and receiving a response packet, and so on, until the bandwidth between X and the communication destination B can be secured.

### [Apparatus Configuration]

An example of the configuration of the communication apparatus of the present disclosure is based on the configuration of the communication apparatus of the first example embodiment and therefore is based on the configuration illustrated in FIG. 1. As in the first example embodiment, the communication apparatus 10 of the present disclosure is provided with a packet identification information acquisition part 11, a packet identification information holding part 12, a transferring part 13, a packet identification information collation determination part 14, and a transmission part 15. The communication apparatus 10 of the present disclosure is characterized in that it is further provided with a bandwidth determination part (not shown in the drawing) and that the transferring part 13 transfers a packet received from a transmission source to at least one other communication apparatus or to the transmission part 15 on a basis of a result determined by the bandwidth determination part.

The bandwidth determination part determines whether or not a communication bandwidth to a transmission destination can be secured. More concretely, for example, the bandwidth determination part determines whether a communication bandwidth can be secured on a basis of, for example, the round trip time (RTT) and packet loss during communication, the status of timeout in responses to ICMP packets, and the like. The determination result is transmitted to the transferring part 13, which transfers a packet on a basis of the determination result. More concretely, when the determination result is that a predetermined bandwidth can be secured, the transferring part 13 transfers a packet received from a transmission source to the transmission part 15 as is. The transmission part 15 transmits out the packet to the transmission destination. When the determination result is that a predetermined bandwidth cannot be secured, the transferring part 13 performs a process of transferring the packet to at least one other communication apparatus.

### [Operation]

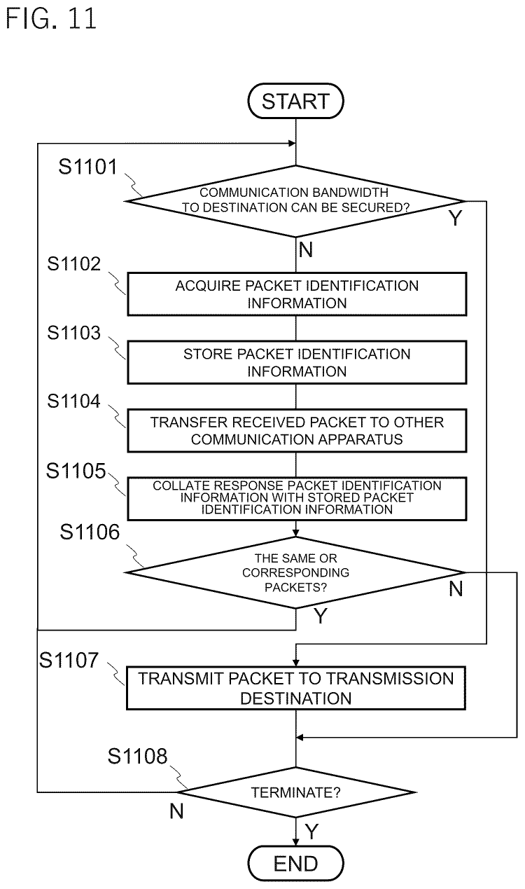

FIG. 11 is a flowchart for explaining an operation of the communication apparatus 10 of the present disclosure. As shown in the drawing, after receiving a packet, the communication apparatus 10 determines whether or not a communication bandwidth to a communication destination can be secured (step S1101). When the determination result is that a communication bandwidth can be secured (Yes in the step S1101), the communication apparatus 10 transmits the packet to the transmission destination (step S1107). When the determination result is that a communication bandwidth cannot be secured (No in the step S1101), the communication apparatus 10 performs transferring processes (steps S1102 to S1105). Note that, since these processes are the same as those in the first example embodiment (steps S41 to S44), the description thereof will be omitted.

When the communication apparatus 10 determines that the response packet and the packet are the same or corresponding packets in a process of collating a response packet identification information with a packet identification information stored (the step S1105), it again performs the process of determining whether or not a communication bandwidth to the communication destination can be secured (the step S1101). When the communication apparatus 10 determines that they are not the same or corresponding packets, it determines whether or not to terminate the operation (step S1108). If it determines not to terminate the operation (No in the step S1108), the communication apparatus 10 again returns to the process of determining whether or not a communication bandwidth to the transmission destination can be secured (the step S1101).

### Effects

According to the communication apparatus 10 of the present disclosure, it is possible to provide a buffering function by transferring packets until a communication bandwidth can be secured on a route to the communication destination. Therefore, it becomes possible to control packet transmission without allocating a storage area for buffering in the communication apparatus 10. The possible buffer capacity [MB] can be calculated by a product of a bandwidth [MB/s] between the communication apparatus 10 and at least one other communication apparatus and a round trip time (RTT).

### Fourth Example Embodiment

In a fourth example embodiment, a communication system provided with the communication apparatus 10 of one of the above example embodiments and at least one other communication apparatus will be described.

### [Apparatus Configuration]

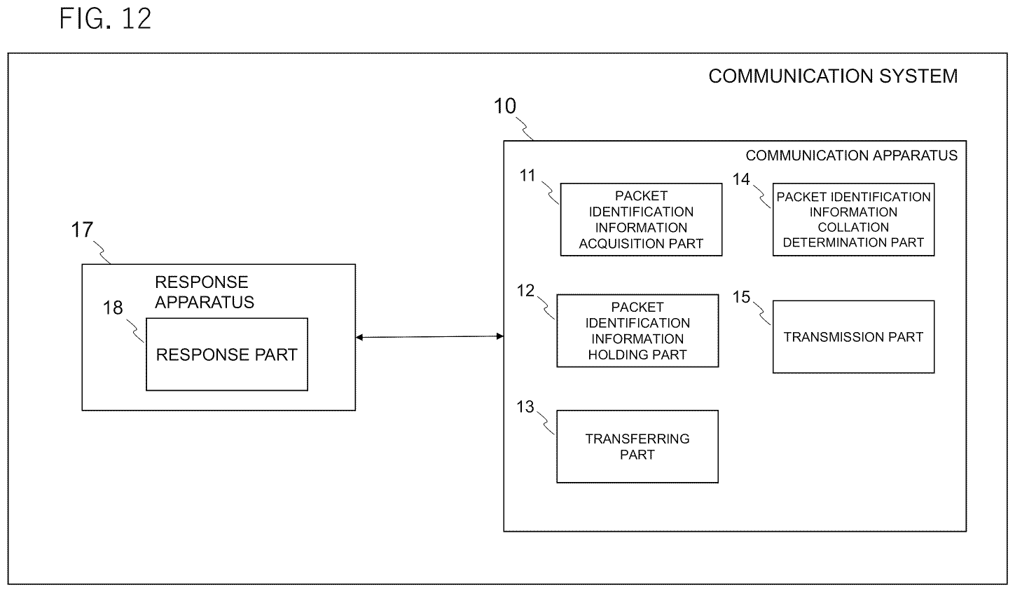

FIG. 12 is a drawing illustrating an example of a configuration of a communication system of the present disclosure. As illustrated in the drawing, the communication system is provided with a response apparatus 17 and a communication apparatus 10. The response apparatus 17 is provided with a response part 18. As in the first example embodiment, the communication apparatus 10 is provided with a packet identification information acquisition part 11, a packet identification information holding part 12, a transferring part 13, a packet identification information collation determination part 14, and a transmission part 15. Note that, since requirements for above configurations of the communication apparatus 10 have already been described in the above example embodiment, the description thereof will be omitted. The communication system of the present example embodiment is characterized in that it is provided with the response apparatus 17 and that the response apparatus 17 is provided with the response part 18.

The response apparatus 17 has communication functionality and communicates with the communication apparatus 10. The response apparatus 17 may be provided on the Internet.

The response part 18 generates a response packet using a payload of a received packet as is to respond. In other words, the response part 18 executes a process of returning the packet to the communication apparatus 10, where it rewrites an address of a communication source and an address of a communication destination, etc., included in a header information of the received packet.

### [Operation]

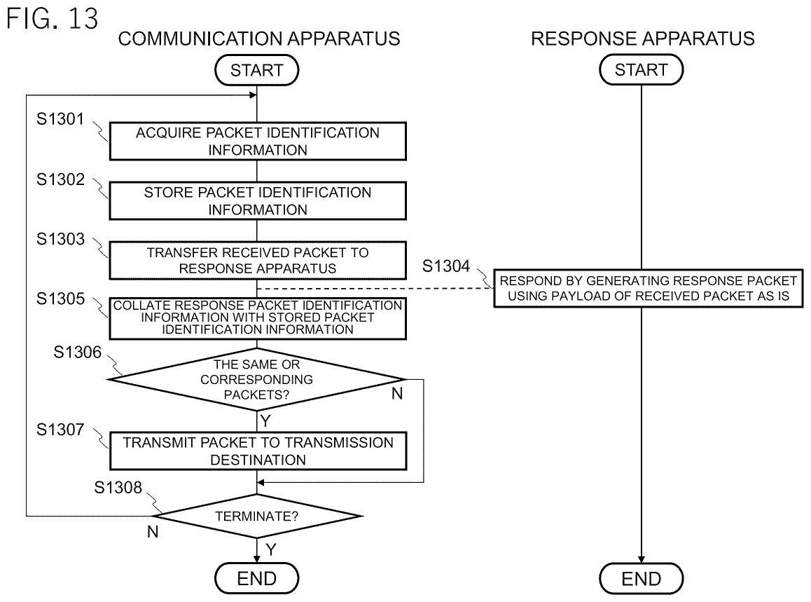

FIG. 13 is a flowchart for explaining an operation of the communication system of the present disclosure. As illustrated in the drawing, in the communication apparatus 10 side, when operation is started, the communication apparatus 10 acquires a packet identification information of a packet received from a transmission source (S1301). The communication apparatus 10 stores the acquired packet identification information in a storage space (step S1302). Next, the communication apparatus 10 transfers the received packet to the response apparatus 17 (step S1303). In the response apparatus 17 side, the response apparatus 17 receives the transferred packet and responds by generating a response packet using a payload of the received packet as is, and transmitting the response packet to the communication apparatus 10 (step S1304). In the communication apparatus 10 side, when receiving the response packet from the response apparatus 17, the communication apparatus 10 collates response packet identification information with packet identification information stored in the storage area (step S1305). As a result of the collation, the communication apparatus 10 determines whether or not the response packet and the packet are the same or corresponding packets (step S1306). If the same or corresponding packet exists (Yes in the step S1306), the communication apparatus 10 transmits the packet to the transmission destination (step S1307) and determines whether or not to terminate the operation (step S1308). If the same or corresponding packet does not exist (No in the step S1306), the communication apparatus 10 determines whether or not to terminate the operation (the step S1308). If the communication apparatus determines not to terminate the operation (No in the step S1308), it receives a transmitted packet again and returns to the process of acquiring the packet identification information therefrom (the step S1301).

### Effects

In the communication system of the present disclosure, the communication apparatus 10 can generate a delay by transferring a packet received from a transmission source to the response apparatus 17. At this time, by utilizing the packet identification information, it is possible to provide a communication apparatus, communication system, communication method, and program capable of generating a sufficient and natural network delay while maintaining data consistency.

A part or a whole of the above-mentioned example embodiments may be described as, but not limited to, the following modes.

### [Mode 1]

A communication apparatus includes:
at least a processor; and
a memory in circuit communication with the processor, wherein the processor is configured to execute program instructions stored in the memory to implement:
a packet identification information acquisition part that acquires packet identification information that identifies a packet received from a transmission source;
a packet identification information holding part that holds the packet identification information;
a transferring part that transfers the packet received to at least one other communication apparatus;
a packet identification information collation determination part that collates response packet identification information that identifies a response packet from the at least one other communication apparatus with the packet identification information held in the packet identification information holding part to determine whether or not the response packet and the packet are the same or corresponding packets; and
a transmission part that transmits the packet to a transmission destination on a basis of a determination result of the packet identification information collation determination part.

### [Mode 2]

In the communication apparatus described in Mode 1, it is preferable that
the packet identification information acquisition part acquires information including at least destination address information of a packet received as the packet identification information, and
the transmission part rewrites a second destination address of the response packet to a destination address in the destination address information held in the packet identification information holding part and transmits the packet to the transmission destination.

### [Mode 3]

In the communication apparatus described in Mode 2, it is preferable that
the packet identification information acquisition part acquires packet identification information based on data of a packet received from the transmission source, and
the packet identification information collation determination part performs collation using the response packet identification information based on the data of the response packet.

### [Mode 4]

In the communication apparatus described in Mode 3, it is preferable that
the packet identification information acquisition part acquires packet identification information including a hash value of a payload of a packet received from the transmission source, and
the packet identification information collation determination part performs collation using the response packet identification information including the hash value of the payload of the response packet as the response packet identification information.

### [Mode 5]

In the communication apparatus described in Mode 1, it is preferable that
when the packet identification information collation determination part collates the response packet identification information with the packet identification information held in the packet identification information holding part and determines that the response packet and the packet are the same or corresponding packets, the transmission part transmits the packet to the transmission destination and deletes the packet identification information of the packet that is determined to be the same or corresponding to the response packet, the packet identification information being held in the packet identification information holding part.

### [Mode 6]

The communication apparatus described in any one of Modes 1 to 5 is preferably further provided with a timeout processing part that deletes the packet identification information, which is held in the packet identification information holding part corresponding to the packet, when the response packet from the at least one other communication apparatus has not been received within a predetermined time after being transferred the packet by the transferring part.

### [Mode 7]

The communication apparatus described in Mode 1 is preferably further provided with a delay policy holding part that holds a delay policy, which is information regarding an element that generates a delay, wherein the transferring part transfers the packet on a basis of the delay policy held in the delay policy holding part.

### [Mode 8]

In the communication apparatus described in Mode 7, it is preferable that
the delay policy holding part holds the delay policy in which the at least one communication apparatus is associated with a node that performs transmission and reception.

### [Mode 9]

In the communication apparatus described in Mode 8, it is preferable that
the delay policy is one of a plurality of delay policies,
the delay policy holding part further holds predicted amounts of delay as the delay policies,
the communication apparatus further comprises:
a required delay amount reception part that receives a required amount of delay; and
a delay policy selection part that selects a delay policy satisfying the required amount of delay from the delay policies held in the delay policy holding part, wherein the transferring part transfers a packet on a basis of the delay policy selected by the delay policy selection part.

### [Mode 10]

In the communication apparatus described in Mode 9, it is preferable that
the delay policy selection part selects a delay policy on a basis of an actual record of round trip times.

### [Mode 11]

The communication apparatus described in Mode 1 is preferably further provided with
a bandwidth determination part that determines whether or not a communication bandwidth to a transmission destination can be secured, wherein
the transferring part transfers the packet received from the transmission source to the at least one other communication apparatus or to the transmission part on a basis of a determination result of the bandwidth determination part.

### [Mode 12]

A communication system includes:
a response apparatus; and
a communication apparatus described in any one of Modes 1 to 11, wherein
the response apparatus comprises:
at least a processor; and
a memory in circuit communication with the processor, wherein the processor is configured to execute program instructions stored in the memory to implement:
a response part that responds by generating a response packet using a payload of a received packet as is, and wherein
the communication apparatus uses the response apparatus as the at least one other communication apparatus.

### [Mode 13]

A communication method causing a computer to execute the following, the communication method includes:
acquiring packet identification information that identifies a packet received from a transmission source;
storing the packet identification information in a storage area;
transferring the packet received to at least one other communication apparatus;
collating response packet identification information that identifies a response packet from the at least one other communication apparatus with the packet identification information stored in the storage area to determine whether or not the response packet and the packet are the same or corresponding packets; and
transmitting the packet to a transmission destination on a basis of a determination result.

### [Mode 14]

The communication method according to Mode 13, wherein
the packet identification information includes at least destination address information of the packet received, and
a second destination address of the response packet is rewritten to a destination address in the destination address information stored in the storage area and the response packet rewritten is transmitted as the packet to the transmission destination.

The Modes 12 to 14 can be expanded in the same manner as Mode 1 is expanded to Modes 2 to 11.

The disclosure of each of above cited PTLs is incorporated herein by reference thereto. Modifications and adjustments of the example embodiments or examples are possible within the scope of the overall disclosure (including the claims) of the pre sent invention and based on the basic technical concept of the present invention. Various combinations and selections of examples and disclosed elements (including the elements in each of the claims, example embodiments, examples, drawings, etc.) are possible within the scope of the claims of the present invention. That is, the present disclosure includes various variations and modifications that could be made by those skilled in the art according to the overall disclosure including the claims and the technical concept. Particularly, any numerical ranges disclosed herein should be interpreted that any intermediate values or subranges falling within the disclosed ranges are also concretely disclosed even without specific recital thereof.

### REFERENCE SIGNS LIST

10: communication apparatus
11: packet identification information acquisition part
12: packet identification information holding part
13: transferring part
14: packet identification information collation determination part
15: transmission part
16: delay policy holding part
17: response apparatus
18: response part
21: communication apparatus X
22: communication management DB
23: other communication apparatus C
24: transmission source A
25: transmission destination B
26, 27, 28: packet
51: CPU
52: memory
53: input/output interface
54: NIC
55: internal bus
61: delay policy DB
62: other communication apparatus #1
63: other communication apparatus #2
64: other communication apparatus #3
65: communication destination D
66: communication destination C
67: communication destination B

What is claimed is:

1. A communication apparatus, comprising:
at least a processor; and
a memory in circuit communication with the processor,
wherein the processor is configured to execute program instructions stored in the memory to implement:
a packet identification information acquisition part that acquires packet identification information that identifies a packet received from a transmission source;
a packet identification information holding part that holds the packet identification information;
a transferring part that transfers the packet received to at least one other communication apparatus;
a packet identification information collation determination part that collates response packet identification information that identifies a response packet from the at least one other communication apparatus with the packet identification information held in the packet identification information holding part to determine whether or not the response packet and the packet are the same or corresponding packets; and
a transmission part that transmits the packet to a transmission destination on a basis of a determination result of the packet identification information collation determination part.

2. The communication apparatus according to claim 1, wherein
the packet identification information acquisition part acquires information including at least destination address information of a packet received as the packet identification information, and
the transmission part rewrites a second destination address of the response packet to a destination address in the destination address information held in the packet identification information holding part and transmits the packet to the transmission destination.

3. The communication apparatus according to claim 2, wherein
the packet identification information acquisition part acquires packet identification information based on data of a packet received from the transmission source, and
the packet identification information collation determination part performs collation using the response packet identification information based on the data of the response packet.

4. The communication apparatus according to claim 3, wherein
the packet identification information acquisition part acquires packet identification information including a hash value of a payload of a packet received from the transmission source, and
the packet identification information collation determination part performs collation using the response packet identification information including the hash value of the payload of the response packet as the response packet identification information.

5. The communication apparatus according to claim 1, wherein
when the packet identification information collation determination part collates the response packet identification information with the packet identification information held in the packet identification information holding part and determines that the response packet and the packet are the same or corresponding packets, the transmission part transmits the packet to the transmission destination and deletes the packet identification information of the packet that is determined to be the same or corresponding to the response packet, the packet identification information being held in the packet identification information holding part.

6. The communication apparatus according to claim 1, further comprising:
a timeout processing part that deletes the packet identification information, which is held in the packet identification information holding part corresponding to the packet, when the response packet from the at least one other communication apparatus has not been received within a predetermined time after being transferred the packet by the transferring part.

7. The communication apparatus according to claim 1, further comprising:
a delay policy holding part that holds a delay policy, which is information regarding an element that generates a delay, wherein
the transferring part transfers the packet on a basis of the delay policy held in the delay policy holding part.

8. The communication apparatus according to claim 7, wherein
the delay policy holding part holds the delay policy in which the at least one communication apparatus is associated with a node that performs transmission and reception.

9. The communication apparatus according to claim 8, wherein
the delay policy is one of a plurality of delay policies,
the delay policy holding part further holds predicted amounts of delay as the delay policies,
the communication apparatus further comprises:
a required delay amount reception part that receives a required amount of delay; and
a delay policy selection part that selects a delay policy satisfying the required amount of delay from the delay policies held in the delay policy holding part, wherein
the transferring part transfers a packet on a basis of the delay policy selected by the delay policy selection part.

10. The communication apparatus according to claim 9, wherein
the delay policy selection part selects a delay policy on a basis of an actual record of round trip times.

11. The communication apparatus according to claim 1, further comprising:
a bandwidth determination part that determines whether or not a communication bandwidth to a transmission destination can be secured, wherein
the transferring part transfers the packet received from the transmission source to the at least one other communication apparatus or to the transmission part on a basis of a determination result of the bandwidth determination part.

12. A communication system comprising:
a response apparatus; and
a communication apparatus according to claim 1, wherein
the response apparatus comprises:
at least a processor; and
a memory in circuit communication with the processor,
wherein the processor is configured to execute program instructions stored in the memory to implement:
a response part that responds by generating a response packet using a payload of a received packet as is, and wherein
the communication apparatus uses the response apparatus as the at least one other communication apparatus.

13. A communication method causing a computer to execute the following, the communication method comprising:
acquiring packet identification information that identifies a packet received from a transmission source;
storing the packet identification information in a storage area;
transferring the packet received to at least one other communication apparatus;
collating response packet identification information that identifies a response packet from the at least one other communication apparatus with the packet identification information stored in the storage area to determine whether or not the response packet and the packet are the same or corresponding packets; and
transmitting the packet to a transmission destination on a basis of a determination result.

14. The communication method according to claim 13, wherein
the packet identification information includes at least destination address information of the packet received, and
a second destination address of the response packet is rewritten to a destination address in the destination address information stored in the storage area and the response packet rewritten is transmitted as the packet to the transmission destination.

15. The communication method according to claim 13, wherein
the packet is transmitted to the transmission destination and the packet identification information of the packet that is stored in the storage area and is determined to be the same or corresponding to the response packet is deleted, when the determination result is that the response packet and the packet are the same or corresponding packets.

16. The communication method according to claim 13, wherein
the packet identification information that is stored in the storage area and corresponds to the response packet is deleted, when the response packet from the at least one other communication apparatus has not been received within a predetermined time after being transferred the packet.

17. The communication method according to claim 13, wherein
the packet received is transferred on a basis of a delay policy, which is information regarding an element that generates a delay.

18. The communication method according to claim 13, further comprising:
determining whether or not a communication bandwidth to a transmission destination can be secured, wherein
the packet received is transferred to the at least one other communication apparatus or is transmitted to the transmission destination, on a basis of a determination result of whether or not the communication bandwidth to the transmission destination can be secured.

19. A non-transitory computer-readable medium storing a program causing a computer to execute:
acquiring packet identification information that identifies a packet received from a transmission source;
storing the packet identification information in a storage area;
transferring the packet received to at least one other communication apparatus;
collating response packet identification information that identifies a response packet from the at least one other communication apparatus with the packet identification information stored in the storage area to determine whether or not the response packet and the packet are the same or corresponding packets; and
transmitting the packet to a transmission destination on a basis of a determination result.
